(19) United States
(12) Patent Application Publication
(10) Pub. No.: US 2018/0060802 A1
(43) Pub. Date: Mar. 1, 2018

(54) STOCK MANAGEMENT SYSTEM FOR FASTENERS

(71) Applicant: TOROS YÖNETIM DANISMANLIK DIS TICARET LIMITED SIRKETI, Istanbul (TR)

(72) Inventor: Ahmet Burak UYGUN, Istanbul (TR)

(21) Appl. No.: 15/560,389

(22) PCT Filed: Mar. 10, 2016
(86) PCT No.: PCT/TR2016/050065

§ 371 Date: Sep. 21, 2017

(30) Foreign Application Priority Data
Mar. 21, 2015 (TR) 2015/03420

(51) Int. Cl. G06Q 10/08; A47F 1/12; A47F 5/00; B25H 3/04; B25H 3/02

(52) U.S. Cl. CPC G06Q 10/087; A47F 1/12; G06K 7/10297; B25H 3/04; B25H 3/02; A47F 5/0025

(57) ABSTRACT

A stock management system which enables users of fasteners and/or manufacturers that stock fasteners to perform the same amount of work or more work with a lower level of fastener stock; and which enables effectively and simply performing the stock follow-up of any kind of product that can fit into toolboxes in various sizes inside the racks in the fastener industry.

### TECHNICAL FIELD

The invention relates to a stock management system that enables effectively and simply performing the stock follow-up of any kind of product that can fit into toolboxes in various sizes inside the rack and that are used in (metal or plastic) fastener (bolt, screw, nut, shim etc.) industry and the method which is performed by this system.

The invention particularly relates to a stock management system and method that enable manufacturers—in the fastener industry—that use and/or stock fasteners to perform the same amount of work or more work with a lower level of fastener stock.

### BACKGROUND OF THE INVENTION

There are various existing stock follow-up systems or applications.
Pay per use sale does not systematically exist in existing applications. Products are directly invoiced to the customer. Therefore, customers carry stock in the amount of products in the rack. (Although there is no complete statistics on this matter, companies generally carry two weeks of stock with the most optimistic approach and this stock level is significantly higher most of the time). In several applications involving pay per use sale, products are directly given to the customer and a person takes stock of all the products at certain times. This isn't a stock management system. For example, if a customer uses 50 kinds of fasteners, these are stored in packages in racks (bulk) and customers manually take as many products as they want from there. All 50 kinds are recounted with a simple scale weekly or monthly and the difference is invoiced. The mentioned counting takes up a lot of time and is physically tiring. Moreover, since counting is performed by means of a scale and screws are usually as lightweight as 2-3 grams; the sample taken in the course of determining the unit weight during counting should at least contain 50 pieces. However, this amount is usually limited to 5-10 pieces and thus many significant counting mistakes occur. This application is based on an order dependent on people and being controlled—managed thereof is not possible.
Products that are in rack at that moment cannot be seen and followed-up. Customers/Manufacturers can't always easily follow abrupt demand changes in the market beforehand. This situation is overcome either by ordering more from suppliers (with more stock) or by taking the risk of disruption/halt of production and pursuing production with minimum amount of stock. The latter happens most of the time and production is definitely affected negatively in this scenario. In the latter, possible needs are tackled by express orders. Express orders constitute additional costs in terms of time, logistics and product supply for suppliers and manufacturers.
Any system with a sensor inside the rack, features such as card design and immediate (or shared with the customer in predefined intervals) information transfer do not currently exist in any system/application. Generally, an additional person is assigned to the manufacturer's factory by the supplier and this person keeps account of the racks. Human error in determination of deficiencies and/or used products/toolboxes may result in significantly negative outcomes.
Systems in existing applications do not have information transfer via Internet from inside the rack or connected to the rack.
In several applications, there are RFID systems placed inside toolboxes. However, these systems are placed in toolboxes, wherein they make the determination by using radio frequency. System is dependent on RFID tags/chips that transfer data by radio frequency. These chips/tags have two types; active and passive tags. Active tags contain a small battery and their read-sense range (generally around 100 meters) differs. These batteries need to be replaced in two-three years. Toolboxes placed in customer racks at different times should be taken to maintenance because of chips/tags placed inside them. This situation causes vulnerabilities in the system. (Determination of worn-out batteries among hundreds/thousands of toolboxes and taking them to maintenance is costly in terms of time and labor). Furthermore, it is not easy to determine toolboxes with worn-out batteries. In active tags, due to the long read range (e.g. 100 meters) it cannot be determined if the toolbox is in the rack, shop floor or in the waiting area to be transferred to the rack. In passive tags, energy is externally (by reader antenna) provided to the tag/chip and consequently sensing range of the tag/chip is much more shorter; rendering external factors such as dust, read/sense angle of antennas important. For example, an obstacle in between may create a problem in sensing of the chip/tag. RFID tag/chip placed inside or on the toolbox is sensitive/vulnerable to various situations in the work environment such as impact, scratch and being crushed. Consequently, RFID systems are very sensitive to environmental factors and they don't work with 100% accuracy. Moreover, there may be maintenance costs and process in RFID systems (In active RFID systems). Finally, in the application/system, there might be several situations regarding removal of the box from the system such as (e.g. an employee of the manufacturer takes the box for his own use and/or the box is left somewhere and/or the box is somehow damaged/broken during use).

In conclusion, the existence of the problems mentioned above and insufficiency of the existing solutions about the matter have necessitated making an improvement on the related technical field.

Object of the Invention

Object of the invention, inspired by the existing situation, is to solve the abovementioned problems

Object of the invention is to enable users and/or manufacturers that keep stock to perform the same amount of work or more work with a lower level of fastener stock.

An object of the invention is to enable effectively and simply performing the stock follow-up of any kind of product that can fit into toolboxes in various sizes inside the rack in the fastener industry.

Other Objects of the Invention;
To transfer immediate stock data to the user; thus respond to demand changes more effectively;
To provide a consistent, reliable and stable system and method;
To provide a structure that is independent of end-user facilities;
To provide a system that is resistant to accidents or stress that might occur under production and/or storage conditions;
To provide a flexible and meanwhile simple system that is easy to follow and manage and that has the minimum level of human input;
To provide a structure that works with the principle of pay per use sale, wherein this principle is not a must;
To enable immediate (or in predefined intervals) follow-up of pay per use products that are in the racks in shop floor and/or storage areas by the customer;
To share consumption/usage data and other statistical information with end-users immediately or in predefined intervals over the internet and/or through the integration to their (customers'/end-users') operating system;
To obtain a consistent and effective stock management system that minimizes communication, information flow, material/human movement with minimum costs.

The structural and characteristic features and all advantages of the invention will be more clearly understood by the figures given below and detailed written description addressed to the figures.

Therefore, evaluation should be done by taking into account these figures and the detailed description.

### FIGURES TO HELP UNDERSTAND THE INVENTION

FIG. 1, is a side view of the stock management system of the invention without Plexiglas.

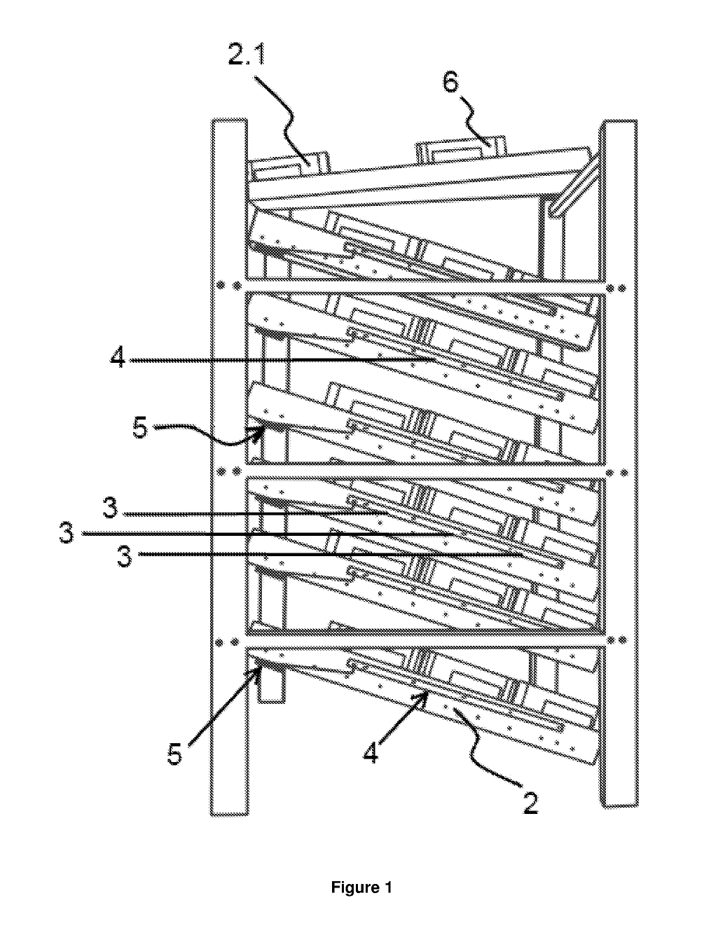

FIG. 2, is a front view of the stock management system of the invention without Plexiglas.

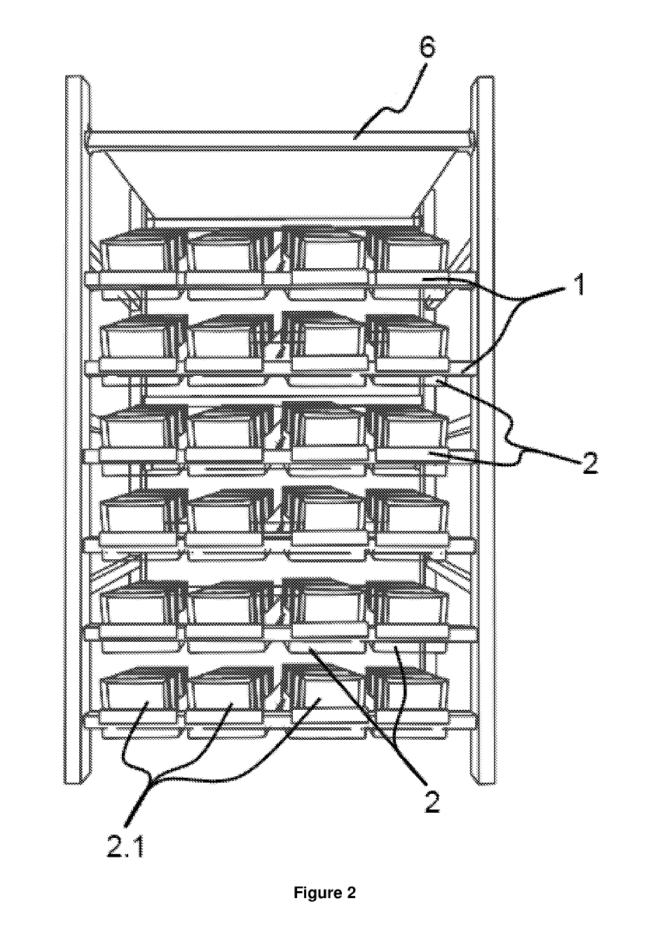

FIG. 3, is a front view of the stock management system of the invention with Plexiglas.

Diagram 1 is a general view of the relationship between components of the stock management system of the invention and the general workflow.

### EXPLANATION OF PART REFERENCES

1. Rack
2. Canal (Toolbox canal)
2.1. Toolbox
3. Sensor
4. Card
5. Mainboard (On the rack canal)
6. Empty rack
6.1. Rack Clearance
7. Code

Drawings do not necessarily have to be scaled and some details that are not essential to understand the present invention may have been omitted. Other than this, at least substantially identical components or components with at least substantially identical functions are designated by the same number.

### DETAILED DESCRIPTION OF THE INVENTION

In this detailed description, preferred embodiments and process steps of the stock management system and method of the invention are described only for the better understanding of the subject.

The invention provides an effective and simple stock management. In the stock method of the invention, products are presented to users/customers in racks (1) provided with sensors (3) inside and in toolboxes (2.1) located inside canals (2) in the racks (1).

These racks (1) are placed in the user's/customer's production plant, storehouse, next to the operator or at suitable locations. Products inside the toolbox (2.1) in the racks (1) are sent to end-user's premises with a dispatch note, i.e. pay per use.

Toolboxes (2.1) (with products inside) are placed in inclined toolbox canals (2) from behind the racks (1). They are consecutively aligned in each canal (2). On the toolbox (2.1), a code (7) (barcode, 2d-code etc.) defining/describing the product inside that toolbox (2.1) is provided. Moreover, a card (4) with sensors (3) is provided on the lateral surface (sides) of each toolbox canal. This card (4) is connected to the mainboard (5) provided on the rear bottom surface of the toolbox canal (2).

In the preferred embodiment of the system, there is an empty rack (6) to place empty toolboxes (2.1).

Since toolbox (2.1) sizes differ, toolbox canals (2) carrying the toolboxes (2.1) may also differ in size. Therefore, the number of consecutively aligned toolboxes (2.1) in the canal may also vary (with respect to toolbox size).

There is always the same product type in toolboxes (2.1) inside the toolbox canal (2). For instance; A and B products do not exist at the same time in a toolbox. The toolbox canal number 10 (2) may take in three toolboxes (2.1) and product A is placed in these toolboxes (2.1). Product B is placed in three toolboxes (2.1) in the toolbox canal number 20 (2).

In the system, one type of product (e.g. product A) may be placed in toolboxes (2.1) in more than one toolbox canal (2) according to end-user consumption rate. Provided that always the same type of product is placed in toolboxes (2.1) in a toolbox canal (2), end-users take toolboxes (2.1) from the front side of the racks (1).

Sensors (3) on sides of toolbox canals (2) may be optic-, mechanic- or magnetic-based. Features of products consumed by end-users, production plant or storage or rack positions are the parameters in determining the sensor (3) type. Type of sensors is determined based on used products, position of racks and external factors. (For example, mechanical sensors are used in dusty environments)

Sensors (3) working with optic, magnetic, barcode reader or mechanic technology inside toolbox canals (2) sense the toolboxes (2.1). These sensors (3) immediately determine the toolbox (2.1) taken from the toolbox canal (2).

Sensors (3) are provided on a card (4). Each toolbox canal (2) is provided with one of these cards (4) with sensors (3) on them. These cards (4) are connected to a mainboard (5), which is also provided in each canal (2). (Cards (4) and mainboards (5) are coated with resin or varnish to be protected from humidity.)

Rack(s) (1), transmit information to the main server in another location/city through 3G connection by a TCP/IP convertor. Information arriving at the server is communicated to the end-user via Internet. Information such as various statistics, immediate information and/or information in certain intervals and amounts can be shared with the end-user through a website that can be accessed by the end-user with a password. If desired; this information can be transferred to end-user's own operating system via e-mail or through the Internet or by establishing direct connection with racks.

In this system, information of used toolbox goes to the server via 3G connection and invoiced. Thus, only used products are invoiced, meaning almost zero stock level. Number of products in a toolbox (2.1) is generally determined according to the consumption level of the customer in the last six months—year. Number of products in a toolbox (2.1) does not exceed the amount used in one shift in the light of historical data and current demand prediction. Therefore, even though product consumption in a toolbox (2.1) is significantly decreased due to an unexpected demand change, stock level remains at the level of a shift. However in other systems, stock in hand (in the most optimistic/positive scenario for the customer) is at least two weeks in case of abrupt demand decrease.

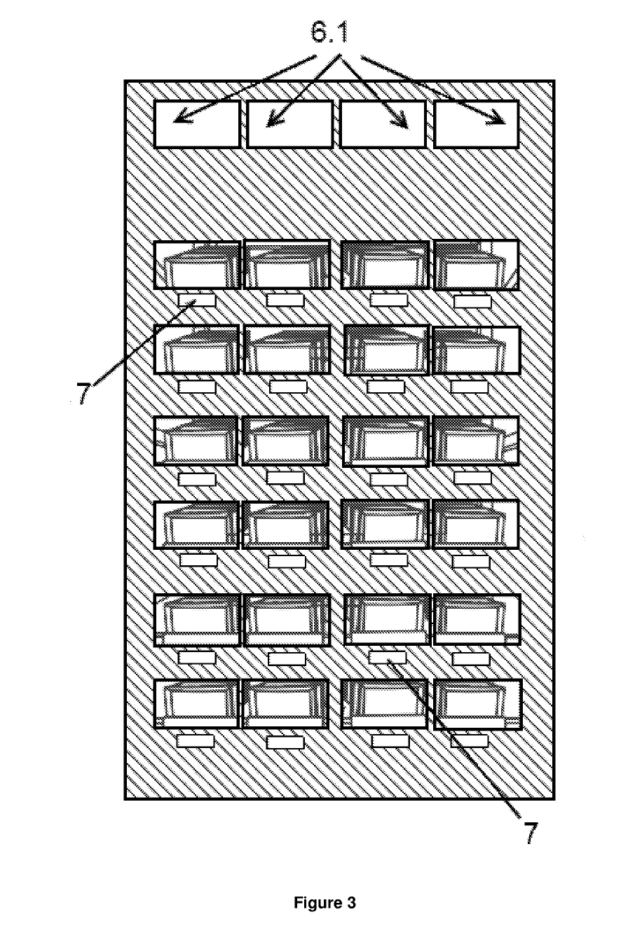

In the system of the invention; four sides of racks (1) are protected by resistant Plexiglas. Rack openings (6.1) that are wide enough to enable toolboxes (2.1) to pass through are provided in the front side and back side of the racks (1) so as to enable the user to take toolboxes (2.1) from the front side and to feed the racks (1) from behind. Description and pictures of the product, various information and warnings are provided on the Plexiglas depending on the end-user and production and/or storage conditions (FIG. 3).

Operators in the production plant and/or storehouse take the toolbox (2.1) of the relevant product when they need it and toolboxes (2.1) behind that slide inside the inclined canal (2) and reach the front side. For example, if there are three toolboxes (2.1) for product A in one canal and if the operator takes one; the system detects the taken toolbox (2.1) immediately by means of sensors (3) and other used toolboxes (2.1) except for this one are invoiced at the end of the day. This situation is beneficial for the supplier. Because if there is a missing product on the rack, then supplier's operating system (7) automatically issues a shipping order in order to complete these products as soon as possible.

Human input and thus margin of error is minimized. In case a new production is started by the user urgently and production tree is completely changed; pay per use goods in racks at that moment relieves this urgency both for the supplier and user.

In the system, information is directly shared with end-users via Internet and by means of the operating system and decision-making process becomes much more simple, effective and easy to follow.

Advantages of the system can be listed as follows:
The system transmits immediate data to the end-user. Therefore it responds better and more effectively when there is a change in demand.
Stock level is usually as much as the amount of products in one toolbox (2.1). This amount is equal to the consumption level in one shift according to historical usage data. In case of sharp demand and/or production plan changes, stock amount is equal only to the amount in one toolbox (2.1).
System provides 100% accurate results. It is reliable and consistent.
Racks (1), sensors (3) or other components of the system are independent of end-user facilities (electricity, internet connection etc.). System can connect to the Internet by means of 3G technology, wherein it is protected against power outage due to the provided battery. Moreover, it is resistant against accidents or stress that might occur in production and/or storage conditions.
It is flexible and also a simple system. It is easy to follow and manage. Human input is minimum.
By this system; stock, time, product shipment and communication related costs for end-users and suppliers are minimized.

This system works with the principle of pay per use sale. However, pay per use sale principle is not a must but it is an important factor in stock level becoming zero or dropping to the amount of products in one toolbox.

When it is considered that for example the average fastener stock level is at best for two weeks in an actually midsized factory (stock level is generally over 4 weeks) and that the stock level drops to the level for two days with the pessimistic/conservative approach in this system; stock level decreases 7-8 fold.

Operation Principle of the System is as Follows:
In the initial installation stage of the system, racks (1) are placed at suitable locations in the factory, where the system will be used. Racks (1) contain the first stock products.
Order is triggered once the user takes the toolbox (2.1) from the rack (1) for purchase/using purposes. Sensors (3) provided in the racks (1) detect products that are decreased.
Detection of products that are taken can be performed in desired periods and/or immediately. For example, detection can be performed once in 6 hours or 8 hours.
Information regarding detected missing product is transmitted to the mainboard (5) by means of the sensor (3). This information is transferred from the mainboard (5) to TCP/IP converter and then to the server via 3G connection. Thus information regarding detected missing product is transferred to the server.
Sharing of stock information with the end-user can be performed in three ways; by an e-mail stating the usage amount of the user (e.g. “your consumption is this much, for your information . . .”); by enabling access to the data bank in a website with a username and password; by integrating the system of the invention with supplier's system (integration of used software)
Invoicing is done correctly because a certain number and same type of product is placed in each toolbox (2.1).
Missing products are dispatched at certain times.

1. Stock management system: which enables users of fasteners and/or manufacturers that stock fasteners to perform the same amount of work or more work with a lower level of fastener stock; and which enables effectively and simply performing the stock follow-up of any kind of product that can fit into toolboxes in various sizes inside racks in the fastener industry, characterized in that said stock management system comprises;
inclined toolbox canals whose bottom surface is positioned on the rack surface with an acute angle and on which toolboxes are placed, in each rack;
at least one card positioned on each toolbox canal;
at least one sensor positioned on the card that is provided in each toolbox canal in order to detect a toolbox that is taken from the toolbox canal immediately;
at least one mainboard, which is positioned in each toolbox canal and to which the card provided with a sensor is connected;
a TCP/IP converter and 3G connection to enable this TCP/IP converter to transfer information to the server; in order to enable transfer of information regarding the toolbox condition in racks to a server and invoicing of used products only.

2. Stock management system according to claim 1, characterized by comprising the supplier server as the server.

3. Stock management system according to claim 1, characterized by comprising an optical sensor or mechanical sensor or magnetic sensor.

4. Stock management system according to claim 1, characterized by comprising a card that is positioned on the lateral surface of each toolbox canal and on which at least one sensor is provided.

5. Stock management system according to claim 1, characterized by comprising a mainboard, to which the card provided with the sensor is connected and which is positioned on the back surface of each toolbox canal.

6. Stock management system according to claim 1, characterized by comprising;
a Plexiglas structure enclosing the racks; and
rack openings that are formed on Plexiglas structure and wide enough to enable toolboxes to pass through, provided in the front side and back side of the racks so as to enable the user to take toolboxes from the front side and to feed the racks from behind.
